(19) United States
(12) Patent Application Publication
(10) Pub. No.: US 2018/0278106 A1
(43) Pub. Date: Sep. 27, 2018

(54) ROTOR FOR INDUCTION MOTOR AND INDUCTION MOTOR

(71) Applicant: Mitsubishi Electric Corporation, Tokyo (JP)

(72) Inventors: Hiroaki MORIYA, Tokyo (JP); Yoshiharu TAKASHIMA, Tokyo (JP); Shinjiro YAMANE, Tokyo (JP); Yoshiki OKADA, Tokyo (JP)

(73) Assignee: Mitsubishi Electric Corporation, Tokyo (JP)

(21) Appl. No.: 15/549,765

(22) PCT Filed: Sep. 21, 2016
(86) PCT No.: PCT/JP2016/077862

§ 371 Date: Aug. 9, 2017

(51) Int. Cl. H02K 1/30; H02K 1/26; H02K 3/12; H02K 17/16

(52) U.S. Cl. CPC H02K 1/30; H02K 17/165; H02K 3/12; H02K 1/26

(57) ABSTRACT

A rotor for an induction motor 300 including end rings having an annular shape, which is provided at an end of a rotor core and is connected to a conductor bar projecting from the end of the rotor core, and first reinforcing members having an annular shape, each of which is provided between the rotor core and the corresponding one of the end rings and is in contact with the corresponding one of the end rings. The first reinforcing members each have an insertion hole formed therein to which the conductor bar projecting from the end of the rotor core is to be inserted.

### FIELD

The present invention relates to a rotor for an induction motor and an induction motor.

### BACKGROUND

In recent years, needs for rotating an induction motor for a machine tool at a higher speed are increasing. An end ring provided in a rotor of an induction motor is deformed by a centrifugal force during high-speed rotation of the rotor. Therefore, every time start-up and stop of the induction motor are repeated or every time a rotational speed of the rotor changes, stress is applied to a point of connection between the end ring and a conductor bar, so that a fatigue life of the rotor is shortened.

A rotor for an induction motor disclosed in Patent Literature 1 includes a rotor core that is a stacked iron core, a shaft penetrating through the rotor core, a conductor bar that penetrates through the rotor core and is a cage bar, an end ring that is an annular short-circuit ring provided at a position away from an end of the rotor core by a certain distance, a first reinforcing member that is an annular support ring provided between the end ring and the shaft, and a second reinforcing member that is an annular shrink-fit ring provided on an outer circumferential portion of the end ring. Because of shrink-fitting of the second reinforcing member on the end ring, a compressive force from the second reinforcing member is applied to the end ring. Due to this, deformation of the end ring during rotation of the rotor is suppressed.

### CITATION LIST

### Patent Literature

Patent Literature 1: Japanese Patent Application Laid-open No. H9-103054

### SUMMARY

### Technical Problem

However, the rotor for an induction motor disclosed in Patent Literature 1 has a problem that, because the conductor bar between the end of the rotor core and the end ring is deformed when the rotor is rotated, an effect of suppressing deformation of the end ring connected to the conductor bar is not expected, so that the rotor has to be replaced with a new one in a shorter period of time than a designed lifetime.

The present invention has been achieved in view of the above problems, and an object of the present invention is to provide a rotor for an induction motor that can suppress reduction in the lifetime thereof.

### Solution to Problem

To solve the above problems and achieve the object, a rotor for an induction motor according to the present invention includes a rotor core, a conductor bar that penetrates through the rotor core in an axial direction along a center axis of the rotor core, an end ring having an annular shape, which is provided at an end of the rotor core and is connected to the conductor bar projecting from the end of the rotor core, and a first reinforcing member that is provided between the rotor core and the end ring and is in contact with the end ring. The first reinforcing member has an insertion hole formed therein to which the conductor bar projecting from the end of the rotor core is to be inserted.

### Advantageous Effects of Invention

An effect is obtained where the rotor for an induction motor according to the present invention can suppress reduction in the lifetime thereof.

### BRIEF DESCRIPTION OF DRAWINGS

FIG. 1 is a cross-sectional view of an induction motor according to an embodiment of the present invention.

FIG. 2 is a cross-sectional view of a rotor for an induction motor according to the embodiment of the present invention.

FIG. 3 is a cross-sectional view taken along a line III-III illustrated in FIG. 2.

FIG. 4 is a perspective view of an end ring illustrated in FIG. 2.

FIG. 5 is a perspective view of a second reinforcing member illustrated in FIG. 2.

FIG. 6 is a side view, when seen from an opposite side of a first reinforcing member illustrated in FIG. 2 to a rotor core.

FIG. 7 is a cross-sectional view taken along a line VII-VII illustrated in FIG. 6.

FIG. 8 is a side view of a comparative example with respect to a first reinforcing member illustrated in FIG. 6.

FIG. 9 is a cross-sectional view taken along a line IX-IX illustrated in FIG. 8.

FIG. 10 is a diagram illustrating deformation of an end ring during rotation of a rotor for an induction motor, which uses the first reinforcing member according to the comparative example illustrated in FIGS. 8 and 9.

FIG. 11 is an explanatory diagram of a state of an end ring when a rotational speed changes in a rotor for an induction motor according to a first modification.

FIG. 12 is an explanatory diagram of a state of an end ring when a rotational speed changes in the rotor for an induction motor according to the embodiment of the present invention.

FIG. 13 is an explanatory diagram of a second modification of the rotor for an induction motor according to the embodiment of the present invention.

FIG. 14 is an explanatory diagram of a modification of the first reinforcing member included in the rotor for an induction motor according to the embodiment of the present invention.

### DESCRIPTION OF EMBODIMENTS

Exemplary embodiments of a rotor for an induction motor and an induction motor according to the present invention will be described in detail below based on the drawings. The present invention is not limited by the embodiments.

### Embodiment

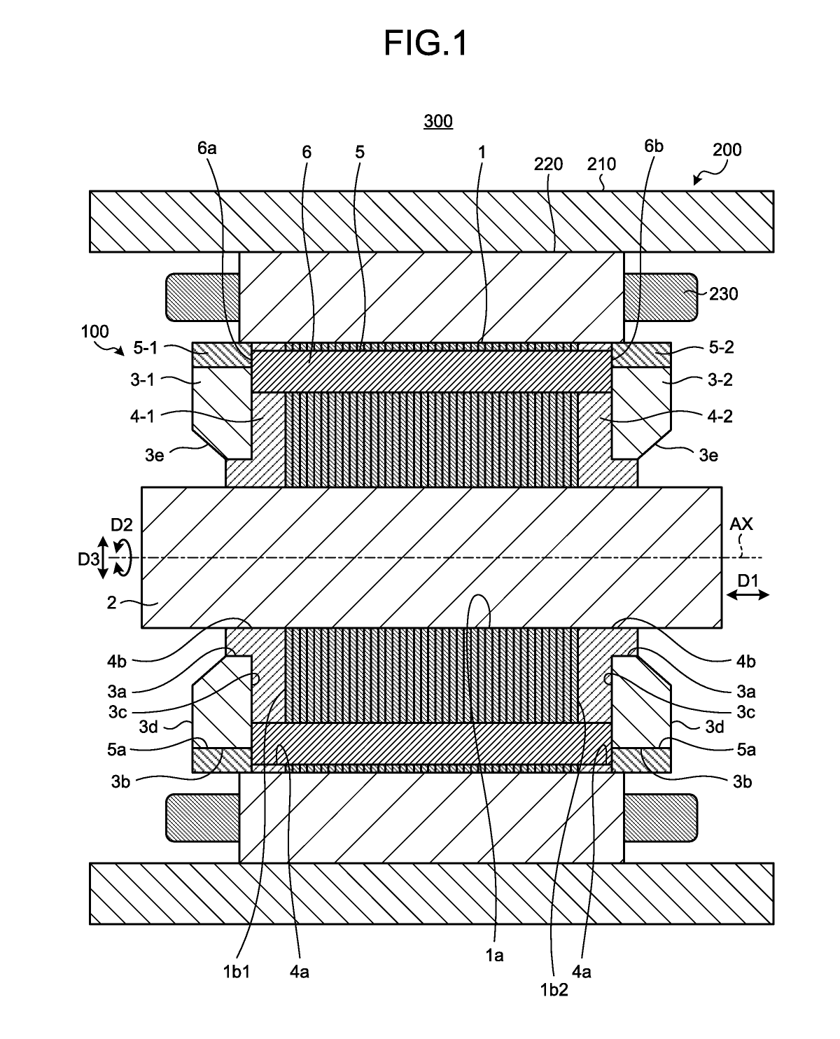

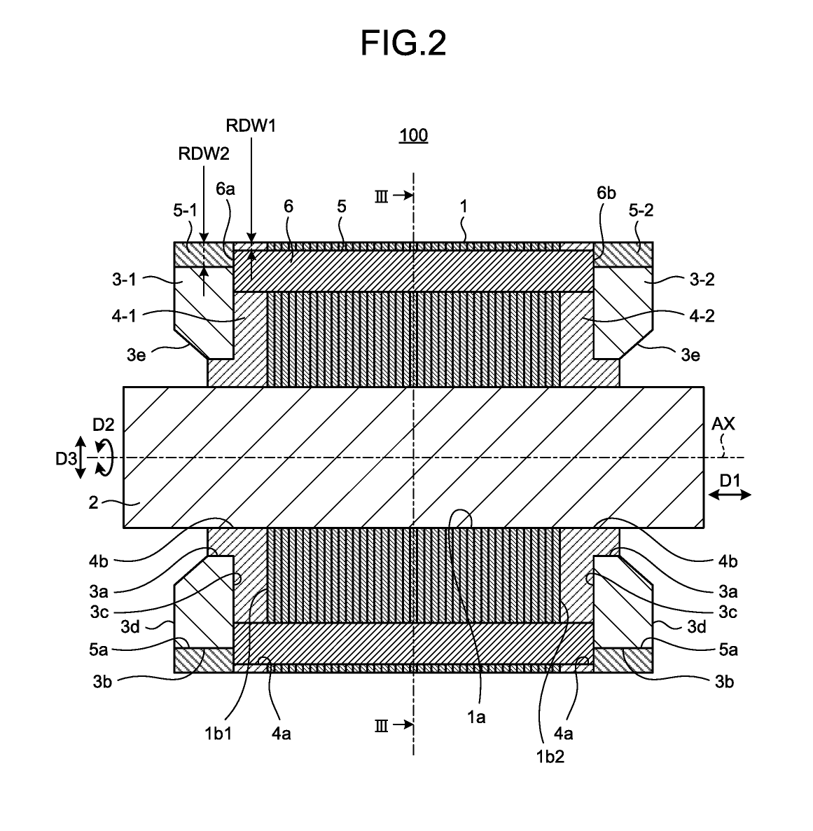

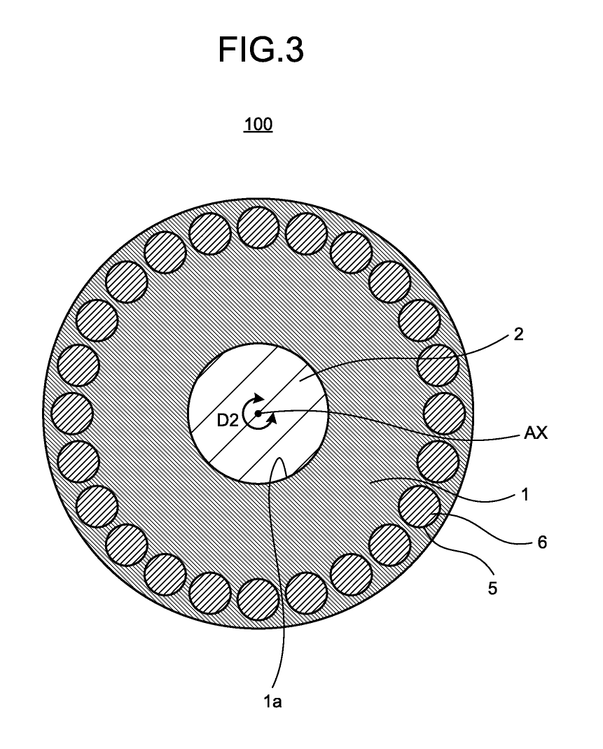

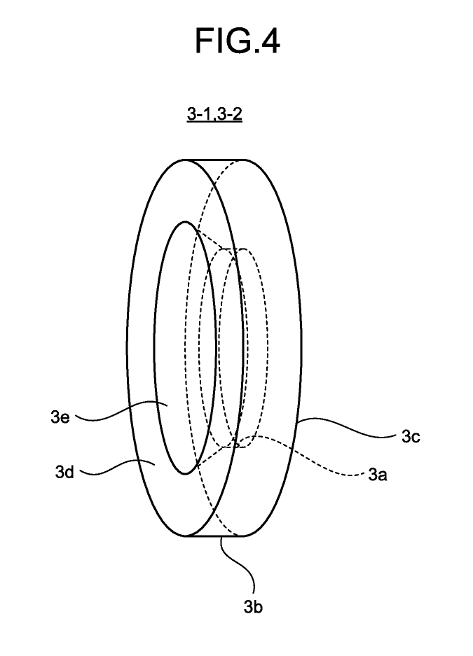

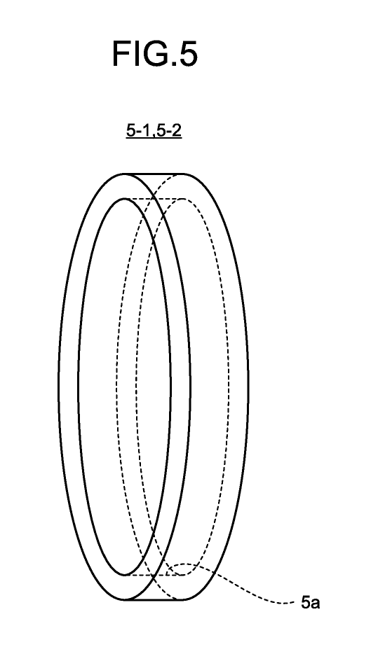

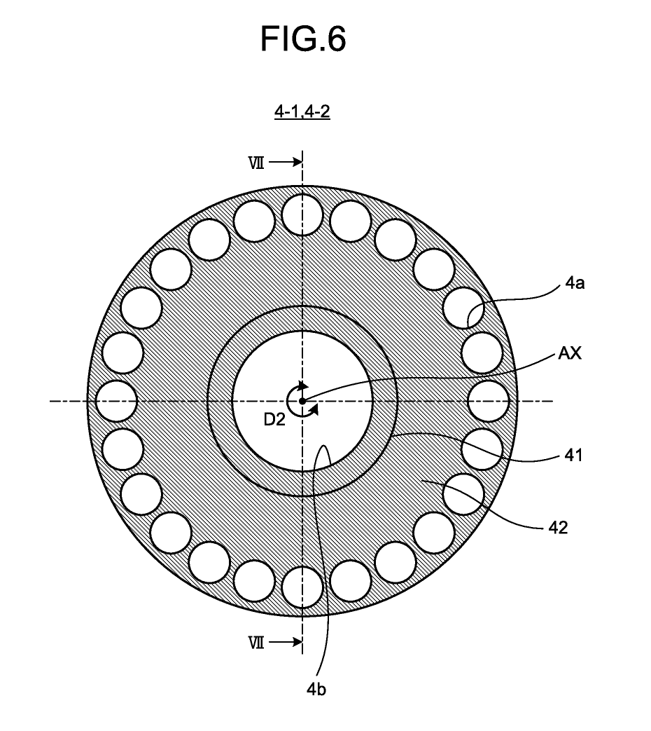

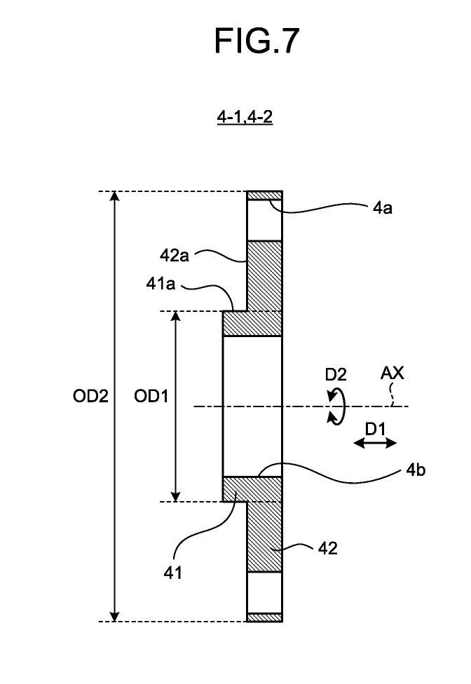

FIG. 1 is a cross-sectional view of an induction motor according to an embodiment of the present invention. FIG. 2 is a cross-sectional view of a rotor for an induction motor according to the embodiment of the present invention. FIG. 3 is a cross-sectional view taken along a line III-III illustrated in FIG. 2. FIG. 4 is a perspective view of an end ring illustrated in FIG. 2. FIG. 5 is a perspective view of a second reinforcing member illustrated in FIG. 2. FIG. 6 is a side view, when seen from an opposite side of a first reinforcing member illustrated in FIG. 2 to a rotor core. FIG. 7 is a cross-sectional view taken along a line VII-VII illustrated in FIG. 6.

An induction motor 300 illustrated in FIG. 1 includes a stator 200 and a rotor 100 provided on an inner side of the stator 200. The stator 200 includes a cylindrical housing 210 and a stator core 220 provided on an inner side of the housing 210. The stator core 220 is formed by stacking a plurality of thin plates punched out from an electromagnetic steel plate (not illustrated) as a base material to have an annular shape, in an axial direction D1 along a center axis AX of a rotor core 1. The thin plates are fixed to each other by swaging, welding, or bonding. A plurality of coils 230 are arranged in the stator core 220. Coil ends of the coils 230 at one end in the axial direction D1 project from one end face of the stator core 220 along the axial direction D1. Coil ends of the coils 230 at the other end in the axial direction D1 project from the other end face of the stator core 220 along the axial direction D1.

The rotor 100 includes the rotor core 1 that is cylindrical and a shaft 2 penetrating through a through hole 1a of the rotor core 1. The rotor core 1 includes a plurality of core slots 5 that are provided in a portion of the rotor core 1 close to an outer circumferential surface of the rotor core 1 and are arranged in an axis-surrounding direction D2 of the center axis AX of the rotor core 1, and a conductor bar 6 that is provided for each of the core slots 5 and penetrates through the rotor core 1 in the axial direction D1.

The rotor 100 also includes an end ring 3-1 having an annular shape, provided at one end 1b1 that is one end of the rotor core 1 in the axial direction D1, a first reinforcing member 4-1 having an annular shape, which is provided between the rotor core 1 and the end ring 3-1 and is in contact with the end ring 3-1, an end ring 3-1 having an annular shape provided on the other end 1b2 that is the other end of the rotor core 1 in the axial direction D1, and a first reinforcing member 4-2 having an annular shape, which is provided between the rotor core 1 and the end ring 3-2 and is in contact with the end ring 3-2.

One end 6a of the conductor bar 6 projecting from the one end 1b1 of the rotor core 1 is connected to the end ring 3-1. An inner circumferential portion 3a of the end ring 3-1 is in contact with the first reinforcing member 4-1. As illustrated in FIGS. 2 and 4, an inclined surface 3e is formed in a portion of the inner circumferential portion 3a of the end ring 3-1 so as to be close to an opposite end 3d of the end ring 3-1 to the rotor core 1. The inclined surface 3e of the end ring 3-1 has such a shape that the inclined surface 3e becomes wider from the rotor core 1 to the end ring 3-1 in the axial direction D1. The other end 6b of the conductor bar 6 projecting from the other end 1b2 of the rotor core 1 is connected to the end ring 3-2. An inner circumferential portion 3a of the end ring 3-2 is in contact with the first reinforcing member 4-2. An inclined surface 3e is formed in a portion of the inner circumferential portion 3a of the end ring 3-2, which is close to an opposite end 3d of the end ring 3-2 to the rotor core 1. The inclined surface 3e of the end ring 3-2 has such a shape that the inclined surface 3e becomes wider from the rotor core 1 to the end ring 3-2 in the axial direction D1. That is, the end rings 3-1 and 3-2 each have the inclined surface 3e in such a manner that an inner diameter increases as the distance from corresponding one of the first reinforcing members 4-1 and 4-2 in the axial direction D1 increases. The reason why the inclined surface 3e is formed in each of the end ring 3-1 and the end ring 3-2 will be described later.

In the first reinforcing member 4-1, an insertion hole 4a is formed to which the conductor bar 6 projecting from the one end 1b1 of the rotor core 1 is to be inserted.

In the first reinforcing member 4-2, an insertion hole 4a is formed to which the conductor bar 6 projecting from the other end 1b2 of the rotor core 1 is to be inserted. An inner diameter of the insertion hole 4a formed in each of the first reinforcing member 4-1 and the first reinforcing member 4-2 is equal to an outer diameter of the conductor bar 6. A through hole 4b is formed in a center portion of each of the first reinforcing member 4-1 and the first reinforcing member 4-2. The shaft 2 penetrates through the through hole 4b of each of the first reinforcing member 4-1 and the first reinforcing member 4-2, and the through hole 1a of the rotor core 1.

The rotor 100 also includes a second reinforcing member 5-1 provided on an outer circumferential portion 3b of the end ring 3-1, and a second reinforcing member 5-2 provided on an outer circumferential portion 3b of the end ring 3-2. An inner circumferential portion 5a of the second reinforcing member 5-1 is in contact with the outer circumferential portion 3b of the end ring 3-1, and an inner circumferential portion 5a of the second reinforcing member 5-2 is in contact with the outer circumferential portion 3b of the end ring 3-2.

In the following description, the end ring 3-1 and the end ring 3-2 may be simply referred to as “end ring(s) 3-1 and/or 3-2”, the first reinforcing member 4-1 and the first reinforcing member 4-2 may be simply referred to as “first reinforcing member(s) 4-1 and/or 4-2”, and the second reinforcing member 5-1 and the second reinforcing member 5-2 may be simply referred to as “second reinforcing member(s) 5-1 and/or 5-2”.

In the present embodiment, outer diameters of the first reinforcing members 4-1 and 4-2, the second reinforcing members 5-1 and 5-2, and the rotor core 1 are equal to one another.

As illustrated in FIG. 2, a width RDW1 from an outer circumferential portion of each of the first reinforcing members 4-1 and 4-2 to the insertion hole 4a is narrower than a width RDW2 from an outer circumferential portion of each of the second reinforcing members 5-1 and 5-2 to the inner circumferential portion 5a. As the width RDW1 of the first reinforcing members 4-1 and 4-2 becomes larger, cross-sectional areas of the one end 6a and the other end 6b of the conductor bar 6 in a radial direction D3 of the rotor core 1 becomes smaller and a resistance value of the conductor bar 6 increases. However, a reinforcing effect for the end rings 3-1 and 3-2 provided by the first reinforcing members 4-1 and 4-2 is improved because of improvement of rigidity of the first reinforcing members 4-1 and 4-2. The reinforcing effect is an effect of suppressing deformation of the end ring 3-1 or 3-2 caused by a centrifugal force and thermal expansion. Details of the reinforcing effect will be described later. Further, as the width RDW2 of each of the second reinforcing members 5-1 and 5-2 becomes larger, a diameter of the end rings 3-1 and 3-2 becomes smaller and an area of contact between each of the end rings 3-1 and 3-2 and the conductor bar 6 becomes smaller. Therefore, resistance values at points of connection of the end rings 3-1 and 3-2 and the conductor bar 6 increase. However, because rigidity of the second reinforcing members 5-1 and 5-2 is improved, a reinforcing effect for the end rings 3-1 and 3-2 respectively provided by the second reinforcing members 5-1 and 5-2 is improved. Therefore, the width RDW1 of each of the first reinforcing members 4-1 and 4-2 and the width RDW2 of each of the second reinforcing members 5-1 and 5-2 are set considering the resistance value between the end rings 3-1 and 3-2 and the conductor bar 6 and the reinforcing effect for the end rings 3-1 and 3-2.

In the present embodiment, the outer diameters of the first reinforcing members 4-1 and 4-2, the second reinforcing members 5-1 and 5-2, and the rotor core 1 are set to be equal to one another. However, the outer diameters may be different from one another. In this case, the same effects as those described above can be obtained when the inner circumferential portions 5a of the second reinforcing members 5-1 and 5-2 are located within the insertion holes 4a of the first reinforcing members 4-1 and 4-2, respectively. In other words, it suffices to employ an arrangement in which the first reinforcing members 4-1 and 4-2 are pressed by the second reinforcing members 5-1 and 5-2, respectively.

The rotor core 1 is formed by stacking a plurality of thin plates, punched out from an electromagnetic steel plate (not illustrated) as a base material to have an annular shape, in the axial direction D1. The thin plats are fixed to each other by swaging, welding, or bonding.

Each of the core slots 5 extends in the axial direction D1 through the rotor core 1 from the one end 1b1 to the other end 1b2. Also, each of the core slots 5 is skewed towards the axis-surrounding direction D2, as illustrated in FIG. 3.

As materials for the end ring 3-1, the end ring 3-2, and the conductor bar 6, a conductor material, such as aluminum, aluminum alloy, copper, or copper alloy, can be used for example. The end rings 3-1 and 3-2 and the conductor bar 6 can be formed by die casting or brazing, which uses the conductor material.

A centrifugal force acting on an object depends not only on a radius and an angular velocity of the object but also on a mass of the object. In order to suppress deformation of the end rings 3-1 and 3-2 caused by a centrifugal force and thermal expansion, the first reinforcing members 4-1 and 4-2 and the second reinforcing members 5-1 and 5-2 have to be designed so as to be hardly deformed by the centrifugal force. Therefore, a material that has a higher tensile strength per unit mass than the material for the end rings 3-1 and 3-2 is used for the first reinforcing members 4-1 and 4-2 and the second reinforcing members 5-1 and 5-2. As the material for the first reinforcing members 4-1 and 4-2 and the second reinforcing members 5-1 and 5-2, iron, titanium, or carbon-fiber reinforced plastic can be used, for example.

As illustrated in FIGS. 6 and 7, the first reinforcing member 4-1 includes a first annular portion 41 that is provided in a portion close to the inner circumferential portion of the first reinforcing member 4-1, and a second annular portion 42 that is provided in a portion close to the outer circumferential portion of the first reinforcing member 4-1 to surround the first annular portion 41. An outer diameter OD2 of the second annular portion 42 is larger than an outer diameter OD1 of the first annular portion 41. Further, a width in the axial direction D1 of the first annular portion 41 is larger than a width in the axial direction of the second annular portion 42. That is, a step is formed by the first annular portion 41 and the second annular portion 42 in the first reinforcing member 4-1. In the second annular portion 42, the insertion holes 4a as illustrated in FIGS. 6 and 7 are provided in a portion close to an outer circumferential portion of the second annular portion 42. The first reinforcing member 4-1 is formed by casting of the first annular portion 41 and the second annular portion 42. However, the first reinforcing member 4-1 may be a combination of the first annular portion 41 and the second annular portion 42 that are fabricated independently of each other. The first reinforcing member 4-2 is formed in the same manner as the first reinforcing member 4-1.

In fabrication of the rotor 100, first, the first reinforcing member 4-1 and the first reinforcing member 4-2 are attached to one end 1b1 and the other end 1b2 of the rotor core 1, respectively. Thereafter, the conductor bar 6 and the end rings 3-1 and 3-2 are cast by die casting using the conductor material described above.

The inner circumferential portion 3a of each of the end rings 3-1 and 3-2 is in contact with an outer circumferential portion 41a of the first annular portion 41 illustrated in FIG. 7. An end 3c of each of the end rings 3-1 and 3-2, which is on a rotor core 1 side, is in contact with an end 42a of the second annular portion 42 that is on a side opposite to the rotor core 1 illustrated in FIG. 7. That is, the end rings 3-1 and 3-2 are arranged to be in contact with the steps in the first reinforcing members 4-1 and 4-2, respectively.

Subsequently, the outer circumferential portion 3b of each of the end rings 3-1 and 3-2 is subjected to cutting, and the outer circumferential portions 3b of the end rings 3-1 and 3-2 after cutting are respectively interference-fitted to the second reinforcing members 5-1 and 5-2 illustrated in FIG. 5. In the present embodiment, the end ring 3-1 is shrink-fitted to the second reinforcing member 5-1, and the end ring 3-2 is shrink-fitted to the second reinforcing member 5-2. Finally, the through hole 4b of each of the first reinforcing members 4-1 and 4-2 and the through hole 1a of the rotor core 1 are subjected to finishing processing to have the same dimensions, and the shaft 2 is interference-fitted to the inside of the through holes 4b and the through hole 1a. In the present embodiment, the shaft 2 is shrink-fitted to the inside of the through holes 4b and the through hole 1a.

Before shrink-fitting of the end rings 3-1 and 3-2 to the second reinforcing members 5-1 and 5-2, X-ray is radiated from an outer circumferential portion 3b side of the end rings 3-1 and 3-2, so that a flaw inspection is performed. The reason why the flaw inspection is performed at this timing is that X-ray that is a suitable energy for inspecting the end rings 3-1 and 3-2 can be hardly penetrated through the second reinforcing members 5-1 and 5-2 in a state where the end rings 3-1 and 3-2 are respectively shrink-fitted to the second reinforcing members 5-1 and 5-2 because of a difference of a specific gravity between materials respectively forming the second reinforcing members 5-1 and 5-2 and the end rings 3-1 and 3-2. By X-ray radiation from the outer circumferential portion 3b side of the end rings 3-1 and 3-2 before the end rings 3-1 and 3-2 are shrink-fitted to the second reinforcing members 5-1 and 5-2, it is possible to inspect the inside of the end rings 3-1 and 3-2 with high accuracy.

A force that spreads outward in the radial direction D3 due to a centrifugal force acts on the end rings 3-1 and 3-2 during rotation. In the present embodiment, the one end 6a of the conductor bar 6 projecting from the one end 1b1 of the rotor core 1 is inserted into the insertion hole 4a of the first reinforcing member 4-1, and the other end 6b of the conductor bar 6 projecting from the other end 1b2 of the rotor core 1 is inserted into the insertion hole 4a of the first reinforcing member 4-2. Therefore, when a centrifugal force acts on the end rings 3-1 and 3-2, both ends of the conductor bar 6 projecting from the rotor core 1 come into contact with the insertion holes 4a of the first reinforcing members 4-1 and 4-2. This contact suppresses deformation of both ends of the conductor bar 6 and also suppresses deformation of the end rings 3-1 and 3-2. Accordingly, because a stress amplitude generated in the end rings 3-1 and 3-2 each time start-up and stop of the rotor 100 are repeated is reduced, or the stress amplitude generated in the end rings 3-1 and 3-2 each time a rotational speed of the rotor 100 changes is reduced, improvement of a fatigue life of the end rings 3-1 and 3-2 can be achieved. In the following description, a reinforcing effect of the end rings 3-1 and 3-2 by the first reinforcing members 4-1 and 4-2 is described specifically.

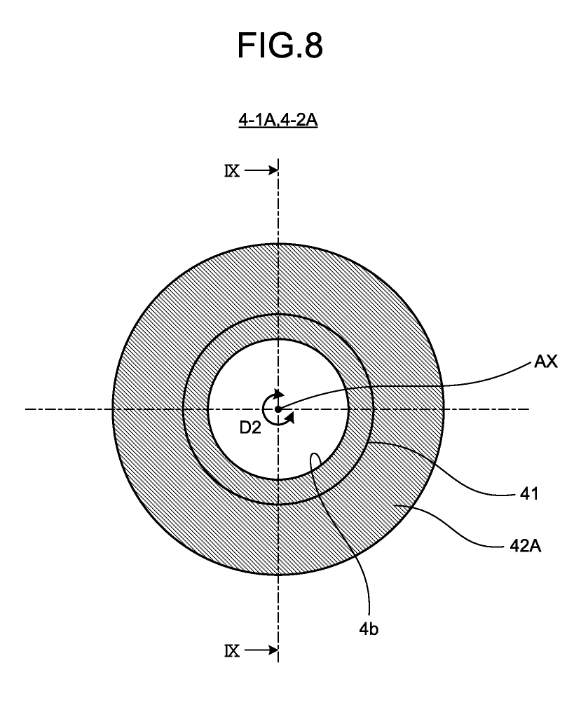

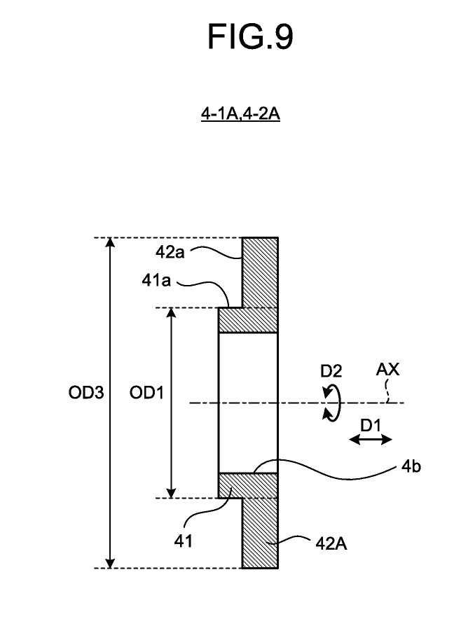

FIG. 8 is a side view of a comparative example with respect to the first reinforcing member illustrated in FIG. 6. FIG. 9 is a cross-sectional view taken along a line IX-IX illustrated in FIG. 8. Differences between the first reinforcing members 4-1 and 4-2 illustrated in FIGS. 6 and 7 and first reinforcing members 4-1A and 4-2A illustrated in FIGS. 8 and 9 are as follows.

(1) Each of the first reinforcing member 4-1A and 4-2A includes a second annular portion 42A in place of the second annular portion 42 illustrated in FIG. 7.

(2) The insertion hole 4a illustrated in FIG. 7 is not provided in the second annular portion 42A, and an outer diameter OD3 of the second annular portion 42A is smaller than the outer diameter OD2 of the second annular portion 42 illustrated in FIG. 7 and is larger than the outer diameter OD1 of the first annular portion 41.

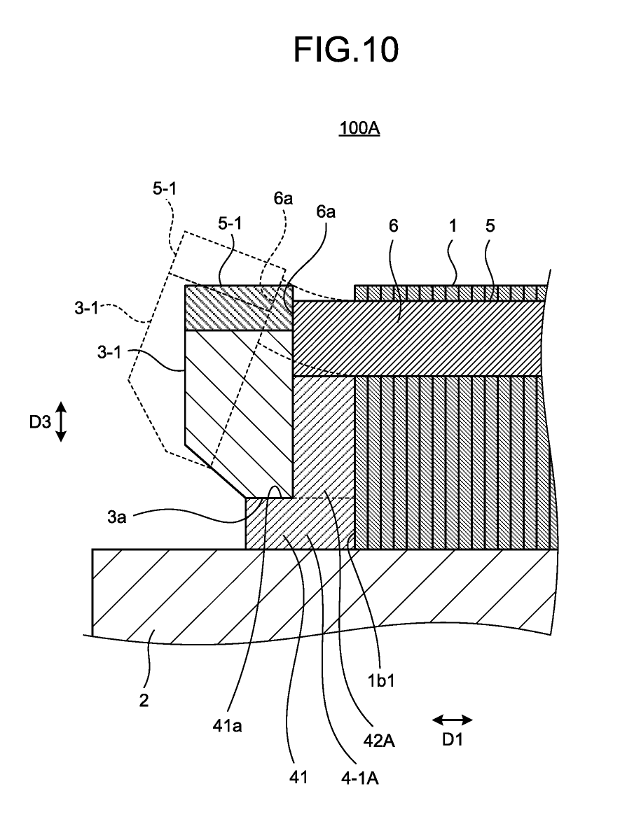

FIG. 10 is a diagram illustrating deformation of an end ring during rotation of a rotor for an induction motor, which uses the first reinforcing member according to the comparative example illustrated in FIGS. 8 and 9. A rotor 100A for an induction motor illustrated in FIG. 10 includes the rotor core 1, the conductor bar 6, the end ring 3-1, and the second reinforcing member 5-1, and also includes the first reinforcing member 4-1A illustrated in FIGS. 8 and 9. As illustrated in FIG. 10, an outer circumferential portion of the second annular portion 42A is in contact with the conductor bar 6. That is, a plurality of the conductor bars 6 are provided to be in contact with outer circumferences of the first reinforcing members 4-1A and 4-2A.

In FIG. 10, outer shapes of the conductor bar 6, the end ring 3-1, and the second reinforcing member 5-1 while the rotor 100A is stopped are illustrated with a solid line, and outer shapes of the conductor bar 6, the end ring 3-1, and the second reinforcing member 5-1 that are deformed during high-speed rotation of the rotor 100A of an induction motor are illustrated with a broken line.

while the rotor 100A is stopped, the inner circumferential portion 3a of the end ring 3-1 is in contact with the outer circumferential portion 41a of the first annular portion 41. Because the second reinforcing member 5-1 is shrink-fitted to the end ring 3-1, a compressive force from the second reinforcing member 5-1 is applied to the end ring 3-1. Therefore, a friction force is generated between the outer circumferential portion 41a of the first annular portion 41 and the inner circumferential portion 3a of the end ring 3-1. This friction force works to suppress deformation of the end ring 3-1 during rotation and during thermal expansion of the rotor 100A.

A force that spreads outward in the radial direction D3 acts on the end ring 3-1 during rotation of the rotor 100A because of a centrifugal force. This force increases with increase of a rotational speed of the rotor 100A, and therefore the end ring 3-1 is deformed with the point of connection to the conductor bar 6 as a fulcrum. In this deformation, the end ring 3-1 resists the friction force generated between the inner circumferential portion 3a of the end ring 3-1 and the outer circumferential portion 41a of the first annular portion 41 to spread outward in the radial direction D3 as illustrated in FIG. 10.

Because an amount of positional deformation of the end ring 3-1 increases with increase of the rotational speed of the rotor 100A, a stress amplitude generated in the end ring 3-1, that is, an amount of positional deformation before rotation in which the rotor 100A is stopped and after the rotation of the rotor 100A becomes larger, as compared with that when the rotational speed of the rotor 100A is low. Every time rotation and stopping of the rotor 100A are repeated or every time the rotational speed of the rotor 100A changes, the inner diameter and the outer diameter of the end ring 3-1 repeat expansion and reduction, so that metal fatigue progresses in the end ring 3-1. Meanwhile, the one end 6a of the conductor bar 6 connected to the end ring 3-1 is deformed outward in the radial direction D3 with the one end 1b1 of the rotor core 1 as a fulcrum with positional deformation of the end ring 3-1. Therefore, each time rotation and stop of the rotor 100A are repeated or each time the rotational speed of the rotor 100A changes, stress is applied to the one end 6a of the conductor bar 6, and therefore metal fatigue in the one end 6a of the conductor bar 6 progresses. Consequently, the rotor 100A may have to be replaced with a new one in a shorter period of time than a designed lifetime.

On the other hand, in the rotor 100 according to the present embodiment, outward deformation in the radial direction D3 of the conductor bar 6 projecting from the one end 1b1 of the rotor core 1 is suppressed by the first reinforcing member 4-1 during rotation, because the one end 6a of the conductor bar 6 is inserted into the insertion hole 4a of the first reinforcing member 4-1. Due to this, deformation of the one end 6a of the conductor bar 6 is suppressed, as compared with that in the rotor 100A illustrated in FIG. 10, and the reinforcing effect for the end ring 3-1 connected to the conductor bar 6 is enhanced. Therefore, in the rotor 100, the stress amplitude generated in the end ring 3-1 is reduced, as compared to that in the rotor 100A illustrated in FIG. 10, so that improvement of the fatigue life of the end ring 3-1 can be achieved. Consequently, reduction in the lifetime of the rotor 100 can be suppressed.

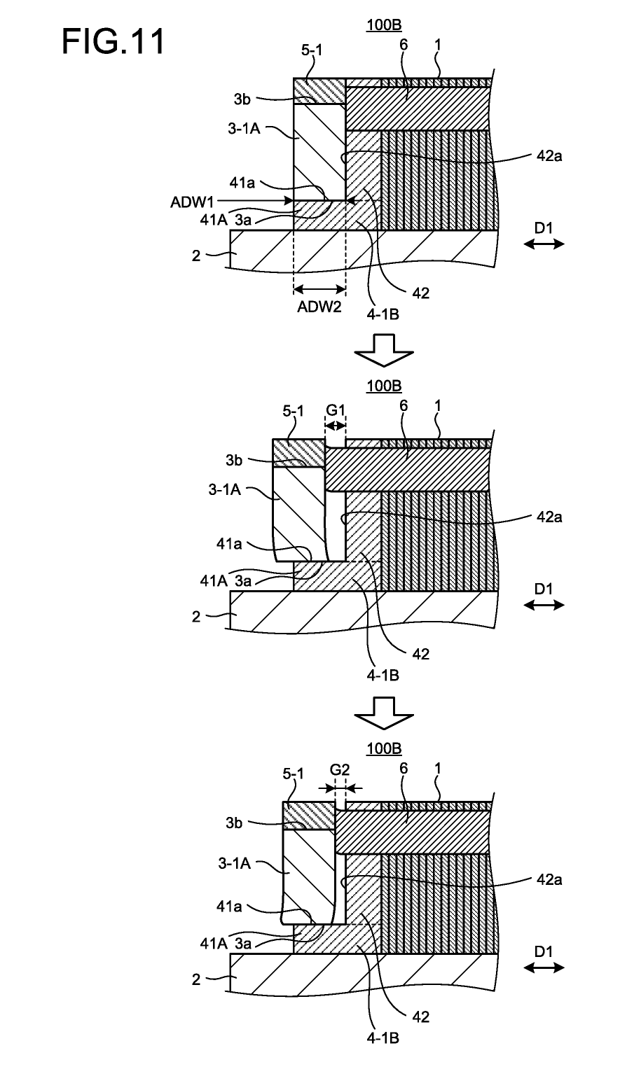

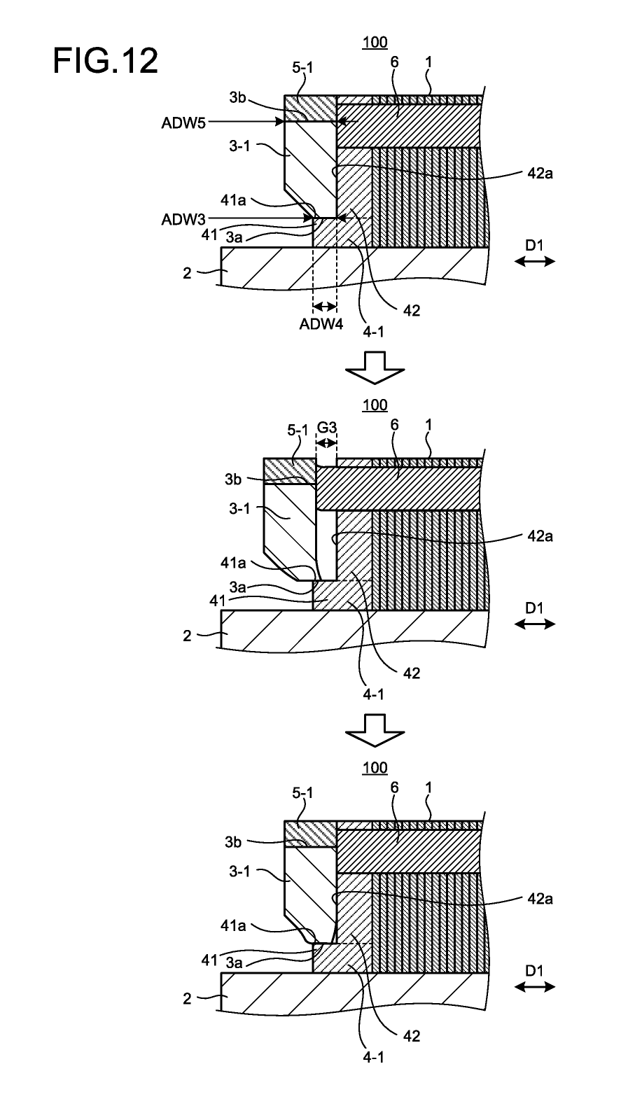

Next, the reason why a width ADW3 in the axial direction D1 of a portion of the inner circumferential portion 3a of each of the end rings 3-1 and 3-2 of the rotor 100 according to the present embodiment, which is in contact with the outer circumferential portion 41a of the first annular portion 41, is narrower than a width ADW5 in the axial direction D1 of the outer circumferential portion 3b of each of the end rings 3-1 and 3-2 is described, referring to FIGS. 11 and 12.

FIG. 11 is an explanatory diagram of a state of an end ring when a rotational speed changes in a rotor of an induction motor according to a first modification. FIG. 12 is an explanatory diagram of a state of an end ring when a rotational speed changes in the rotor of an induction motor according to the embodiment of the present invention. The rotor 100 according to the embodiment of the present invention is described in FIG. 12. A rotor 100B that is a first modification of the rotor 100 according to the present embodiment is described in FIG. 11. FIGS. 11 and 12 each illustrate the rotors in a stop state, a high-speed rotation state, and a time at which each rotor returns from the high-speed rotation state to the stop state, from top of each of the figures in this order.

Even when the rotor 100B of FIG. 11 is used, it is possible to obtain the effect according to the present embodiment in that outward positional deformation in the radial direction D3 of the end ring 3-1A and the conductor bar 6 by a centrifugal force during rotation is suppressed, because the conductor bar 6 is inserted into an through hole of a first reinforcing member 4-1B.

Differences between the rotor 100B illustrated in FIG. 11 and the rotor 100 illustrated in FIG. 12 are as follows.

(1) The rotor 100B illustrated in FIG. 11 includes an end ring 3-1A in place of the end ring 3-1 illustrated in FIG. 12, and includes the first reinforcing member 4-1B in place of the first reinforcing member 4-1 illustrated in FIG. 12.

(2) The first reinforcing member 4-1B includes a first annular portion 41A in place of the first annular portion 41 illustrated in FIG. 12.

(3) Regarding the rotor 100 illustrated in FIG. 12, as for deformation of the conductor bar 6 caused by thermal expansion, an effect of suppressing reduction in the lifetime of a rotor can be obtained as compared with the rotor 100B illustrated in FIG. 11.

In the rotor 100B illustrated in FIG. 11, an inner circumferential portion 3a of the end ring 3-1A is entirely in contact with an outer circumferential portion 41a of the first annular portion 41A, and a width ADW1 in the axial direction D1 of the inner circumferential portion 3a of the end ring 3-1A is equal to a width in the axial direction D1 of the outer circumferential portion 3b of the end ring 3-1A. Further, in the rotor 100B, a width ADW2 in the axial direction D1 of the outer circumferential portion 41a of the first annular portion 41A is equal to the width ADW1 of the inner circumferential portion 3a of the end ring 3-1A.

On the other hand, in the rotor 100 illustrated in FIG. 12, the width ADW3 in the axial direction D1 of the portion of the inner circumferential portion 3a of the end ring 3-1, which is in contact with the outer circumferential portion 41a of the first annular portion 41, is narrower than the width ADW5 in the axial direction D1 of the outer circumferential portion 3b of the end ring 3-1. Further, in the rotor 100, a width ADW4 in the axial direction D1 of the outer circumferential portion 41a of the first annular portion 41 is narrower than the width ADW5 of the outer circumferential portion 3b of the end ring 3-1 and is equal to the width ADW3 of the inner circumferential portion 3a of the end ring 3-1. The width ADW3 of the inner circumferential portion 3a of the end ring 3-1 illustrated in FIG. 12 is narrower than the width ADW1 of the inner circumferential portion 3a of the end ring 3-1A illustrated in FIG. 11, and the width ADW4 of the outer circumferential portion 41a of the first annular portion 41 illustrated in FIG. 12 is narrower than the width ADW2 of the outer circumferential portion 41a of the first annular portion 41A illustrated in FIG. 11.

In the rotor 100B in a stop state illustrated in a first diagram from top of FIG. 11, the end ring 3-1A is in contact with the end 42a of the second annular portion 42.

When a rotor is driven to rotate, the temperature rises due to heat generation, so that members of the rotor are thermally expanded. Because the end rings 3-1 and 3-2 and the conductor bar 6 are formed from a member having a large coefficient of thermal expansion, shape deformation is caused by thermal expansion. When the rotor is stopped, the temperature decreases. Therefore, because of shape change caused by heat cycle, the lifetime of the rotor may be shortened. In FIGS. 11 and 12, deformation in the axial direction D1 that is largely influenced by thermal expansion is focused for simply describing the effect of the thermal expansion.

In the rotor 100B, because the temperature rises with increase of a rotational speed, the conductor bar 6 thermally expands in the axial direction D1, and the end ring 3-1A moves in the axial direction D1 while resisting a friction force between the outer circumferential portion 41a of the first annular portion 41A and the inner circumferential portion 3a of the end ring 3-1A, as illustrated in a second diagram from top in FIG. 11. Because the end ring 3-1A moves away from the second annular portion 42, a gap G1 is generated between the end 42a of the second annular portion 42 and the end ring 3-1A.

Thereafter, because the temperature decreases with decrease of the rotational speed of the rotor 100B, the end ring 3-1A moves in the axial direction D1 to come close to the second annular portion 42 by thermal shrinkage of the conductor bar 6, as illustrated in a third diagram from top in FIG. 11. The movement of the end ring 3-1A stops when a shrinking force of the conductor bar 6 and the friction force between the outer circumferential portion 41a of the first annular portion 41A and the inner circumferential portion 3a of the end ring 3-1A are balanced with each other. Consequently, a gap G2 that is narrower than the gap G1 is generated between the second annular portion 42 and the end ring 3-1A. Part of the conductor bar 6 exists within the gap G2 is not supported by the second annular portion 42, and therefore a reinforcing effect with respect to outward deformation in the radial direction D3 of the end ring 3-1A by a centrifugal force is reduced, as compared with a case where no gap G2 is generated.

Regarding the friction force between the end ring 3-1 and the first reinforcing member 4-1, there is actually a non-linear relation between a load and the friction force, and therefore the friction force tends to be smaller as an area of contact between two objects is narrower. Because the width ADW3 of the inner circumferential portion 3a of the end ring 3-1 in FIG. 12 is narrower than the width ADW5 of the outer circumferential portion 3b of the end ring 3-1, an area of contact between the first annular portion 41 and the end ring 3-1 in FIG. 12 is smaller than an area of contact between the first annular portion 41A and the end ring 3-1A in FIG. 11. Therefore, the friction force between the outer circumferential portion 41a of the first annular portion 41 and the inner circumferential portion 3a of the end ring 3-1 is smaller than the friction force between the outer circumferential portion 41a of the first annular portion 41A and the inner circumferential portion 3a of the end ring 3-1A illustrated in FIG. 11. In the following description, the friction force between the outer circumferential portion 41a of the first annular portion 41 and the inner circumferential portion 3a of the end ring 3-1 is simply referred to as “first friction force”, and the friction force between the outer circumferential portion 41a of the first annular portion 41A and the inner circumferential portion 3a of the end ring 3-1A illustrated in FIG. 11 is simply referred to as “second friction force”.

In the rotor 100 in a stop state illustrated in the first diagram from top in FIG. 12, the end ring 3-1 is in contact with the end 42a of the second annular portion 42.

As the rotational speed of the rotor 100 increases, the end ring 3-1 resists the friction force between the outer circumferential portion 41a of the first annular portion 41 and the inner circumferential portion 3a of the end ring 3-1 to move in the axial direction D1 because of thermal expansion of the conductor bar 6, as illustrated in the second diagram from top in FIG. 12. Because the end ring 3-1 moves away from the second annular portion 42, a gap G3 is generated between the end 42a of the second annular portion 42 and the end ring 3-1, and the one end 6a of the conductor bar 6 is drawn to be elastically deformed.

Thereafter, as the rotational speed of the rotor 100 decreases, the end ring 3-1 moves in the axial direction D1 by the shrinking force of the conductor bar 6, as illustrated in a third diagram from top in FIG. 12.

Because the first friction force in the rotor 100 is smaller than the second friction force in the rotor 100B illustrated in FIG. 11 as described above, a gap generated between the end 42a of the second annular portion 42 and the end ring 3-1 can be made smaller than the gap G2 illustrated in FIG. 11 or can be eliminated in the rotor 100. Consequently, according to the rotor 100, it is possible to enhance the reinforcing effect of suppressing outward deformation in the radial direction D3 of the end ring 3-1 caused by a centrifugal force during rotation, as compared with that in the rotor 100B illustrated in FIG. 11.

Even in a case where the width ADW3 of the inner circumferential portion 3a of the end ring 3-1 illustrated in FIG. 12 is equal to the width ADW5 of the outer circumferential portion 3b of the end ring 3-1, the first friction force in the rotor 100 becomes smaller than the second friction force in the rotor 100B illustrated in FIG. 11 by making the width ADW4 of the outer circumferential portion 41a of the first annular portion 41 narrower than the width ADW5 of the outer circumferential portion 3b of the end ring 3-1. However, from a viewpoint of suppressing progress of degradation of the end rings 3-1 and 3-2, it is desirable to provide the inclined surface 3e described above in each of the end rings 3-1 and 3-2 to make the width ADW3 of the inner circumferential portion 3a of the end ring 3-1 narrower than the width ADW5 of the outer circumferential portion 3b of the end ring 3-1. This is described below.

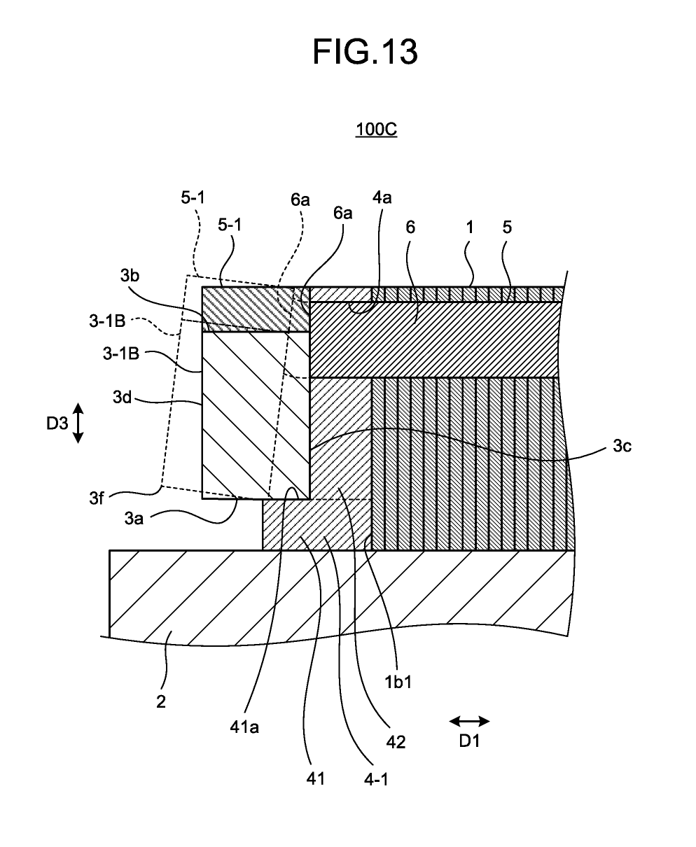

FIG. 13 is an explanatory diagram of a second modification of the rotor for an induction motor according to the embodiment of the present invention. FIG. 13 illustrates a partial enlarged view of a rotor 100C according to the modification. Differences between the rotor 100C and the rotor 100 illustrated in FIG. 2 are as follows.

(1) The rotor 100C includes an end ring 3-1B in place of the end ring 3-1 illustrated in FIG. 2.

(2) In the end ring 3-1B, the inclined surface 3e illustrated in FIG. 2 is omitted, an inner circumferential portion 3a of the end ring 3-1B has a flat surface shape, and a width in the axial direction D1 of the inner circumferential portion 3a of the end ring 3-1B is equal to a width in the axial direction D1 of an outer circumferential portion 3b of the end ring 3-1B. The width in the axial direction D1 of the outer circumferential portion 41a of the first annular portion 41 is narrower than the width in the axial direction D1 of the outer circumferential portion 3b of the end ring 3-1B.

FIG. 13 illustrates outer shapes of the conductor bar 6, the end ring 3-1B, and the second reinforcing member 5-1 while the rotor 100C is stopped, with a solid line, and illustrates outer shapes of the conductor bar 6, the end ring 3-1B, and the second reinforcing member 5-1 that are deformed during high-speed rotation of the rotor 100C, with a broken line.

Because the end ring 3-1B is connected to the one end 6a of the conductor bar 6 provided in a portion of the rotor core 1 which is close to an outer circumferential surface of the rotor core 1, the end ring 3-1B during rotation of the rotor 100C is deformed with a point of connection to the one end 6a of the conductor bar 6 as a fulcrum. Therefore, the largest stress amplitude larger than those generated in any portion other than a corner 3f is generated in the corner 3f between the inner circumferential portion 3a and an end 3d of the end ring 3-1B.

Specifically, the stress amplitude generated in a portion close to the inner circumferential portion 3a of the end ring 3-1B is larger than the stress amplitude generated in a portion close to the outer circumferential portion 3b of the end ring 3-1B. Further, the stress amplitude generated in a portion of the end ring 3-1B close to the end 3d that is on an opposite side to the rotor core 1 is larger than the stress amplitude generated in a portion of the end ring 3-1B close to an end 3c on a rotor core 1 side. Therefore, because the largest amplitude of the stress in the entire end ring 3-1B is generated in the corner 3f between the inner circumferential portion 3a and the end 3d of the end ring 3-1B, which is located at a farthest position from the fulcrum during rotation, the corner 3f is deteriorated earliest in the entire end ring 3-1B, and deterioration of the end ring 3-1B progresses from the corner 3f as a start point.

In the end ring 3-1 of the rotor 100 illustrated in FIG. 2, the inclined surface 3e is formed between the inner circumferential portion 3a and the end 3d of the end ring 3-1. In the end ring 3-1 with the inclined surface 3e formed therein, a portion that is deteriorated earliest in the entire end ring 3-1 is removed, and therefore the rotor 100 illustrated in FIG. 2 can achieve improvement of a fatigue life of the end ring 3-1, as compared with the rotor 100C illustrated in FIG. 13. The inclined surface 3e of each of the end rings 3-1 and 3-2 illustrated in FIG. 2 is not limited to a flat surface shape, but may be curved.

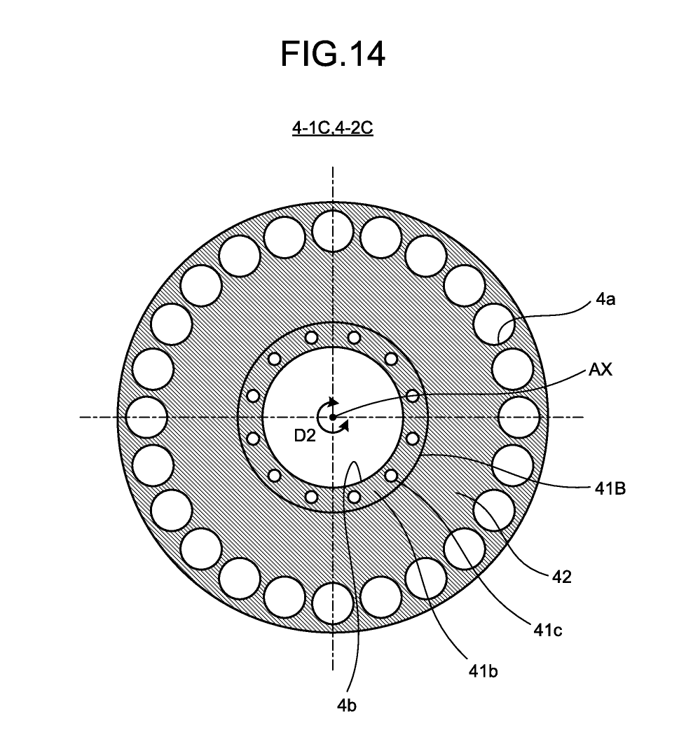

FIG. 14 is an explanatory diagram of a modification of the first reinforcing member included in the rotor for an induction motor according to the embodiment of the present invention. Differences between the first reinforcing members 4-1 and 4-2 illustrated in FIG. 6 and first reinforcing members 4-1C and 4-2C illustrated in FIG. 14 are as follows.

(1) The first reinforcing members 4-1C and 4-2C each include a first annular portion 41B in place of the first annular portion 41 illustrated in FIG. 6.

(2) An end 41b of the first annular portion 41B, on an opposite side to the rotor core 1, has a plurality of screw holes 41c that are formed therein and are arranged in the axis-surrounding direction D2.

Because a plurality of the insertion holes 4a are formed in the second annular portion 42, the weight of the rotor 100 may become unbalanced due to positions and sizes of the insertion holes 4a. The imbalance means that the distances between the insertion holes 4a adjacent in the axis-surrounding direction D2 are not even, or the distances from centers of the insertion holes 4a arranged in the axis-surrounding direction D2 to the center axis AX are not even. Due to this imbalance, vibration occurs during rotation of the rotor 100. In the rotor 100 provided with the first reinforcing members 4-1C and 4-2C, a screw (not illustrated) is tightened into part of the screw holes 41c formed in the first annular portion 41B, so that the imbalance of the weight is improved. Examples of a method for improving the imbalance of the weight are a method for cutting out a portion of the first reinforcing member(s) 4-1C and/or 4-2C to improve the imbalance of the weight and a method for applying a ballast material typified by epoxy resin onto the first reinforcing member(s) 4-1C and/or 4-2C to improve the imbalance of the weight, other than the method for providing the screw holes 41c. However, in the first reinforcing members 4-1C and 4-2C illustrated in FIG. 14, the imbalance of the weight can be improved only by tightening the screw (not illustrated) into the screw hole 41c, and therefore a work for correcting the imbalance of the weight can be simplified, and a manufacturing time of the rotor 100 can be shortened.

Although the rotor 100 including the second reinforcing members 5-1 and 5-2 is described in the present embodiment, the second reinforcing members 5-1 and 5-2 may be omitted. Even in a case where the second reinforcing members 5-1 and 5-2 are omitted, deformation of the end rings 3-1 and 3-2 can be suppressed at a rotational speed lower than a certain rotational speed, because the first reinforcing members 4-1 and 4-2 are provided in the rotor 100. With the second reinforcing members 5-1 and 5-2, deformation of the end rings 3-1 and 3-2 can be also suppressed in a range of a rotational speed higher than the certain rotational speed.

Further, although an example where the conductor bar 6 is formed by die casting in the first reinforcing members 4-1 and 4-2 that are manufactured in advance is described in the present embodiment, the first reinforcing members 4-1 and 4-2 may be formed by shrink-fitting after the conductor bar 6 is formed by brazing. In a case where the first reinforcing members 4-1 and 4-2 are shrink-fitted to the conductor bar 6, it is likely that a portion of the plural conductor bars 6 expands because of contact with the first reinforcing members 4-1 and 4-2, to cause the first reinforcing members 4-1 and 4-2 in the middle of fitting to be stopped at unintended positions. Forming the first reinforcing members 4-1 and 4-2 by die casting can suppress reduction of a yield caused by a failure of manufacturing of the first reinforcing members 4-1 and 4-2.

The configuration described in the above embodiment are only an example of the content of the present invention. The configuration can be combined with other well-known techniques, and a part the configuration can be omitted or modified without departing from the gist of the present invention.

### REFERENCE SIGNS LIST

1 rotor core
1a, 4b through hole
1b1, 6a one end
1b2, 6b other end
2 shaft
3-1, 3-1A, 3-1B, 3-2 end ring
3a, 5a inner circumferential portion
3b, 41a outer circumferential portion
3c, 3d, 41b, 42a end
3e inclined surface
3f corner
4-1, 4-1A, 4-1B, 4-1C, 4-2 first reinforcing member
4a insertion hole
core slot
5-1, 5-2 second reinforcing member
6 conductor bar
41, 41A, 41B first annular portion
41c screw hole
42, 42A second annular portion
100, 100A, 100B, 100C rotor
200 stator
210 housing
220 stator core
230 coil
300 induction motor

1. A rotor for an induction motor comprising:
a rotor core;
a conductor bar that penetrates through the rotor core in an axial direction along a center axis of the rotor core;
an end ring having an annular shape, which is provided at an end of the rotor core and is connected to the conductor bar projecting from the end;
a first reinforcing member that is provided between the rotor core and the end ring and is in contact with the end ring; and
a second reinforcing member that is provided on an outer circumferential portion of the end ring and has an inner circumferential portion that is in contact with the outer circumferential portion of the end ring, wherein
the first reinforcing member has an insertion hole formed therein to which the conductor bar projecting from the end is to be inserted.

2. (canceled)

3. A rotor for an induction motor comprising:
a rotor core;
a conductor bar that penetrates through the rotor core in an axial direction along a center axis of the rotor core;
an end ring having an annular shape, which is provided at an end of the rotor core and is connected to the conductor bar projecting from the end;
a first reinforcing member that is provided between the rotor core and the end ring and is in contact with the end ring; and wherein
the first reinforcing member has an insertion hole formed therein to which the conductor bar projecting from the end is to be inserted,
the first reinforcing member includes
a first annular portion, and
a second annular portion that is provided on an outer circumference of the first annular portion and has a smaller width in the axial direction than the first annular portion, and
the insertion hole is formed in the second annular portion.

4. The rotor for an induction motor according to claim 3, wherein a width in the axial direction of a portion of the end ring, which is in contact with an outer circumferential portion of the first annular portion, is narrower than a width in the axial direction of an outer circumferential portion of the end ring.

5. A rotor for an induction motor comprising:
a rotor core;
a conductor bar that penetrates through the rotor core in an axial direction along a center axis of the rotor core;
an end ring having an annular shape, which is provided at an end of the rotor core and is connected to the conductor bar projecting from the end;
a first reinforcing member that is provided between the rotor core and the end ring and is in contact with the end ring; and wherein
the first reinforcing member has an insertion hole formed therein to which the conductor bar projecting from the end is to be inserted, wherein the end ring has an inner diameter that increases as moving away from a portion that is in contact with the first reinforcing member in the axial direction.

6. The rotor for an induction motor according to claim 1, wherein the first reinforcing member has a plurality of screw holes formed therein that are arranged in an axis-surrounding direction of the center axis of the rotor core, and
the plurality of screw holes are formed on an end of the first reinforcing member on an opposite side to the rotor core.

7. An induction motor comprising the rotor for an induction motor according to claim 1.

8. The rotor for an induction motor according to claim 3, wherein the first reinforcing member has a plurality of screw holes formed therein that are arranged in an axis-surrounding direction of the center axis of the rotor core, and
the plurality of screw holes are formed on an end of the first reinforcing member on an opposite side to the rotor core.

9. The rotor for an induction motor according to claim 5, wherein the first reinforcing member has a plurality of screw holes formed therein that are arranged in an axis-surrounding direction of the center axis of the rotor core, and
the plurality of screw holes are formed on an end of the first reinforcing member on an opposite side to the rotor core.

10. An induction motor comprising the rotor for an induction motor according to claim 3.

11. An induction motor comprising the rotor for an induction motor according to claim 5.
